(19) United States
(12) Patent Application Publication
(10) Pub. No.: US 2023/0031309 A1
(43) Pub. Date: Feb. 2, 2023

(54) Method and System for Providing Users with an Open Opinion Marketplace Analysis

(71) Applicant: Matthew Kinash, Edmonton (CA)

(72) Inventor: Matthew Kinash, Edmonton (CA)

(21) Appl. No.: 17/876,374

(22) Filed: Jul. 28, 2022

Related U.S. Application Data
(60) Provisional application No. 63/226,492, filed on Jul. 28, 2021.

(51) Int. Cl. G06Q 30/02; G06Q 40/04

(52) U.S. Cl. CPC G06Q 30/0203; G06Q 30/0201; G06Q 40/04

(57) ABSTRACT

A method for providing users with an open opinion marketplace analysis is presented. The present invention obtains and provides useful stock information in a quick and easy manner. This stock information is posted in the form of stock opinions associated with a plurality of stock opinion profiles. The posted stock opinions dictate a reliability score, which is used to calculate an accumulative reliability score of the user profile that posted the stock opinion.

### FIELD OF THE INVENTION

The present invention relates generally to method for stock analysis. More specifically, the present invention is a method and system for providing users with an open opinion marketplace analysis.

### BACKGROUND OF THE INVENTION

Investors of stock rely on important decisions in order to make a profit. Many investors are not able to sufficiently research the stock market and make informed decisions for their portfolios. These users do not have the ability to do this because researching said stock market subject matter is either too expensive or too time consuming. Conventional systems include community based forums, but the information in these community based forums are deemed too unreliable, thus are difficult to gauge accuracy of stock opinions derived from community based forums. Stock advisement boards that utilize financial advising teams are also too complicated for many investors to understand and come with expensive subscriptions. Therefore, it is an objective of the present invention to provide a means of an open opinion marketplace that incorporates a means of gauging reliability of stock opinions.

The present invention aims to solve these problems. The present invention is a method and system for providing users with an open opinion marketplace analysis. The present invention obtains useful stock information quickly. The present invention provides a web platform marketplace where users are free to post or buy stock opinions. Once an individual posts an opinion, the individual must wait the full duration of that opinion for STM Points (reliability points) allocation. This reliability point allocation is based on the stock opinion's chosen stock volatility (the year high of the stock/the year low=volatility), duration of the stock opinion (opinion expiration time), and the profitability of the stock opinion (how much the chosen stock changes in value). These STM Points help the user determine the reliability of the opinion seller and helps the users determine the risk level of the information they buy. The price of an opinion is a fraction of our competitors and the ability to view the reliability of a seller is a new extension to market that no one else has implemented yet. The creation of a comprehensive reliability rating of a seller of stock opinions is new to the market. This reliability rating consists of a five-star rating, STM Points (explained below), and the track record of the seller (how many correct/incorrect opinions). The algorithm determines how many STM Points (reliability points) the seller can win or lose through their opinion based on if they are correct or not. This process is new to the market. The algorithm is based off of; stock opinion's chosen stock volatility (the year high of the stock/the year low=volatility), duration of the stock opinion (how long till the opinion expires), and the profitability of the stock opinion (how much the chosen stock changes in value).

### SUMMARY OF THE INVENTION

The present invention obtains and provides useful stock information in a quick and easy manner. This stock information is posted in the form of stock opinions associated with a plurality of stock opinion profiles. The posted stock opinions dictate a reliability score, which is used to calculate an accumulative reliability score of the user profile that posted the stock opinion.

### BRIEF DESCRIPTION OF THE DRAWINGS

FIG. 1 is a flowchart illustrating overall process for the present invention.

FIG. 2 is a flowchart illustrating continuing the overall process for the present invention from FIG. 1.

FIG. 3 is a flowchart illustrating continuing the overall process for the present invention from FIG. 2.

FIG. 4 is a flowchart illustrating the process of processing a transaction for a selected matching opinion.

FIG. 5 is a flowchart illustrating the process of defining an active stock opinion or an expired stock opinion based on an expiration time.

FIG. 6 is a flowchart illustrating the process of generating a ranked list of at least one matching opinion.

FIG. 7 is a flowchart illustrating the process of generating an opinion accumulative opinion score.

FIG. 8 is a flowchart illustrating the process of generating the ranked list of at least one matching opinion based on the accumulative opinion score.

FIG. 9 is a flowchart illustrating the process of generating a stock opinion.

FIG. 10 is a block diagram of the hardware used in the present invention.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, and devices for facilitating exchange and transaction of currencies, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an

FTP server, a virtual server, a proxy server, a DNS server etc.), a quantum computer, and so on. Further, one or more client devices and/or the server computer may be configured for executing a software application such as, for example, but not limited to, an operating system (e.g., Windows, Mac OS, Unix, Linux, Android, etc.) in order to provide a user interface (e.g., GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

The present invention is a method for providing users with an open opinion marketplace analysis. The present invention obtains and provides useful stock information in a quick and easy manner. This stock information is posted in the form of stock opinions associated with a plurality of stock opinion profiles. The present invention is executed through a series of steps:

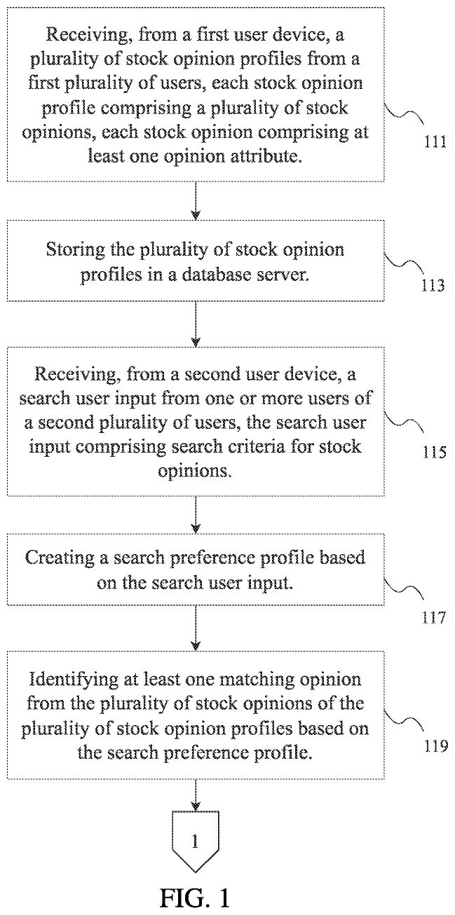

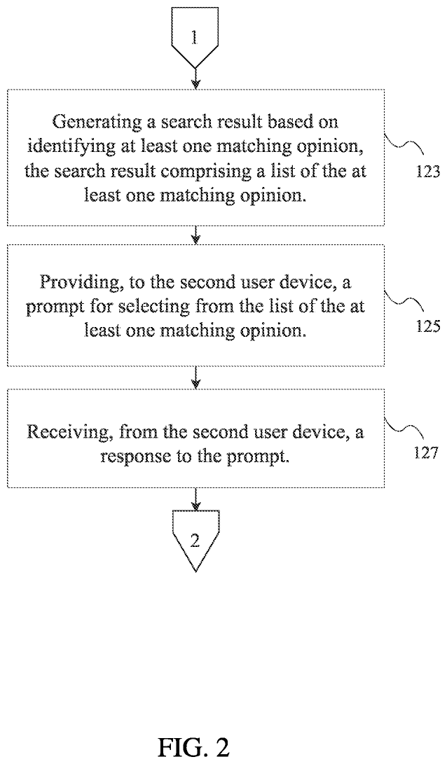

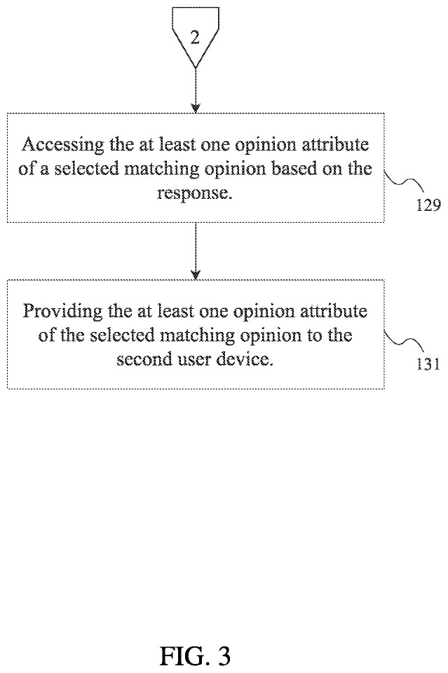

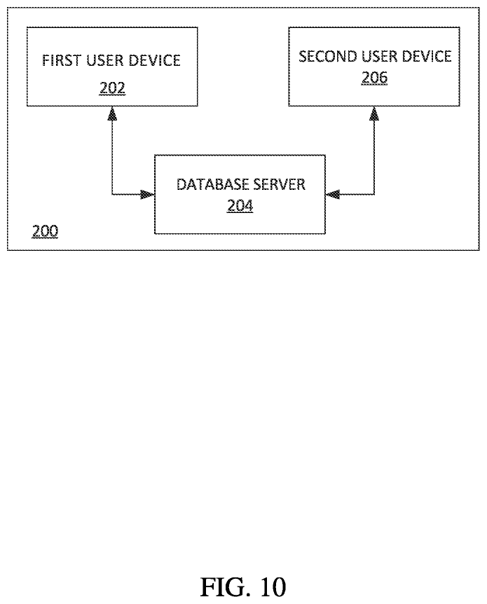

In reference to FIGS. 1-3, the plurality of stock opinion profiles from a first plurality of users, where each stock opinion profile comprises a plurality of stock opinions, and where each stock opinion comprises at least one opinion attribute is first received from a first user device 202 (Step 111). In the preferred embodiment, the plurality of stock opinion profiles takes the form of registered user accounts associated with the present invention, where the plurality of users takes the form of end-users associated with giving or receiving stock opinions in the present invention. The plurality of stock opinions takes the form of input data from the plurality of users that pertain to stock market analytics, specifically focused on stock profit/loss trends. In the preferred embodiment, the at least one opinion attribute takes the form of any suitable attributed associated with stock market analytics such as, but not limited to stock field, stock opinion information, profit/loss graphs or any other suitable information. In the preferred embodiment, the first user device 202 takes the form of any suitable device associated with user input of the plurality of first users. More specifically, the first user device 202 is a device suitable for processing, storing, or handling user input information pertaining to the plurality of first users, such as, but not limited to desktop computers, laptops, kiosks, portable communication devices, smartphones, tablets, or any other suitable device. Next, the plurality of stock opinion profiles is stored in a database server (Step 113). In the preferred embodiment, the database server takes the form of any suitable data storage unit such as, but not limited to database servers. Next, a search user input from one or more users of a second plurality of users, where the search user input comprises search criteria for stock opinions is received from a second user device 206 (Step 115). In the preferred embodiment, the search user input takes the form of user input data associated with the plurality of second plurality users. More specifically, the search user input takes the form of any suitable user input data pertaining to searching stock opinions or stock opinion profiles, where the search criteria for stock opinions can include, but are not limited to stock field, keywords, user search, or any other suitable search criteria. In the preferred embodiment, the second user device 206 takes the form of any suitable device associated with user input of the plurality of second users. More specifically, the second user device 206 is a device suitable for processing, storing, or handling user input information pertaining to the plurality of second users, such as, but not limited to desktop computers, laptops, kiosks, portable communication devices, smartphones, tablets, or any other suitable device. In reference to FIG. 10, the first user device 202, the second user device 206, and the database server 204 are communicably coupled to each other along the overall marketplace hardware system 200. Next, a search preference profile is created based on the search user input (Step 117). Next, at least one matching opinion from the plurality of stock opinions of the plurality of stock opinion profiles is identified based on the search preference profile (Step 119). Next, a search result is generated based on identifying at least one matching opinion, where the search result comprises a list of the at least one matching opinion (Step 123). In the preferred embodiment, the search preference profile takes the form of an aggregation of search user input data sufficient for finding the at least one matching opinion. The search result takes the form of an aggregation of the at least one matching opinion, where said aggregation is organized into the list of at least one matching opinion. Next, a prompt for selecting from the list of the at least one matching opinion is provided to the second user device 206 (Step 125). Next, a response to the prompt is received from the second user device 206 (Step 127). Next, the at least one opinion attribute of a selected matching opinion is accessed based on the response (Step 129). Finally, the at least one opinion attribute of the selected matching opinion is provided to the second user device 206 (Step 131). In the preferred embodiment, the prompt serves as a user selectable interface along the second user device 206 that allows the plurality of second users to send the response to the prompt, where the selected matching opinion is accessed based on the response. Upon the selection of the selected matching opinion, the at least one opinion attribute is displayed to the second user device 206, allowing the plurality of second users to view the at least one attribute of the selected matching opinion.

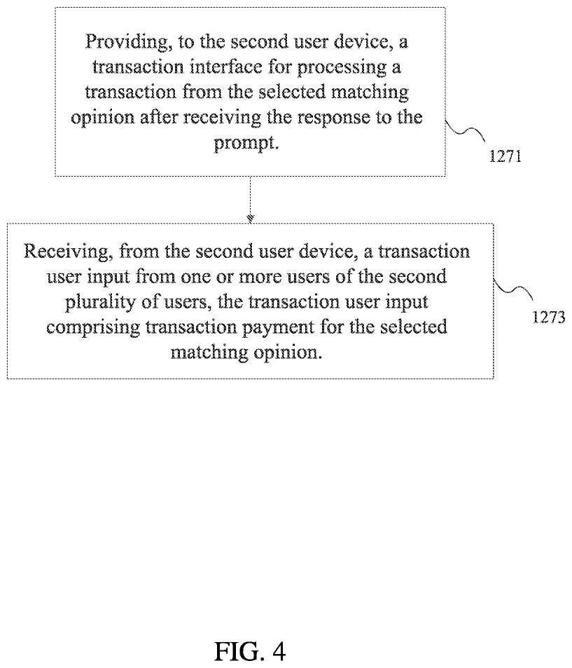

In reference to FIG. 4, a transaction interface for processing a transaction from the selected matching opinion after receiving the response to the prompt is provided to the second user device 206 (Step 1271). A transaction user input from one or more users of the second plurality of users, where the transaction user input comprises transaction payment for the selected matching opinion is received from the second user device 206 (Step 1273). In the preferred embodiment, the transaction interface allows a user from the plurality of second users to buy the selected matching opinion in order to access the at least one opinion attribute of the selected and purchased selected matching opinion. The transaction takes the form of any suitable electronic transaction. In the preferred embodiment, the transaction user input takes the form of transaction data suitable for fulfilling the transaction purchase.

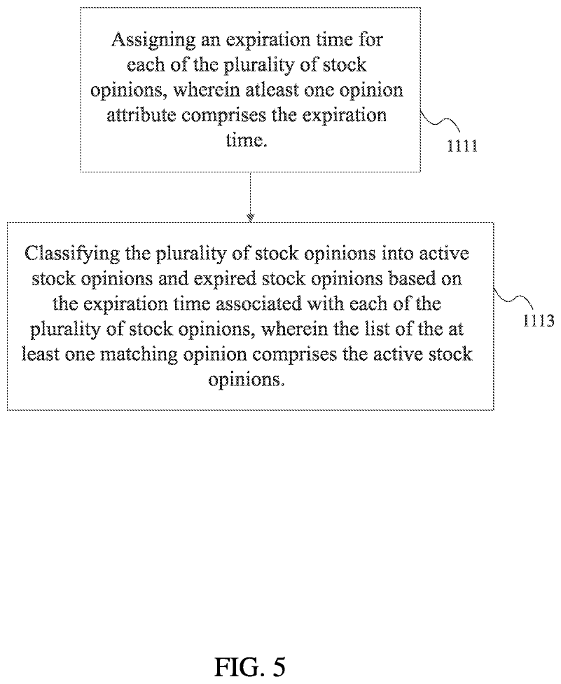

In reference to FIG. 5, an expiration time is assigned for each of the plurality of stock opinions, where at least one opinion attribute comprises the expiration time (Step 1111). The plurality of stock opinions is classified into active stock opinions and expired stock opinions based on the expiration time associated with each of the plurality of stock opinions, where the list of the at least one matching opinion comprises the active stock opinions (Step 1113). In the preferred embodiment, the expiration time may take the form of an inputted time associated with the plurality of first users. In another embodiment, the expiration time may take the form of a pre-set inputted time.

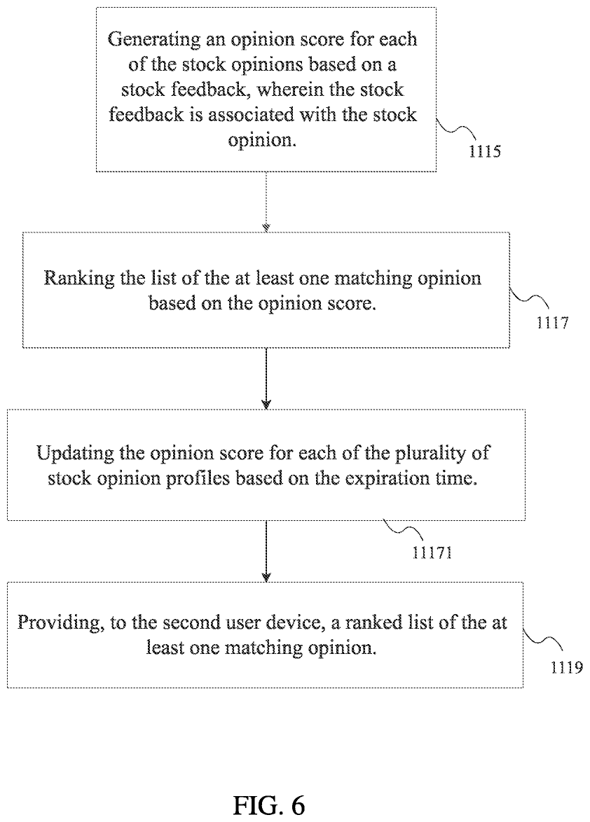

In reference to FIG. 6, an opinion score for each of the stock opinions is generated based on a stock feedback, wherein the stock feedback is associated with the stock opinion (Step 1115). The list of the at least one matching opinion is ranked based on the opinion score (Step 1117). A ranked list of the at least one matching opinion is provided to the second user device 206 (Step 1119). The opinion score is updated for each of the plurality of stock opinion profiles based on the expiration time (Step 11171).

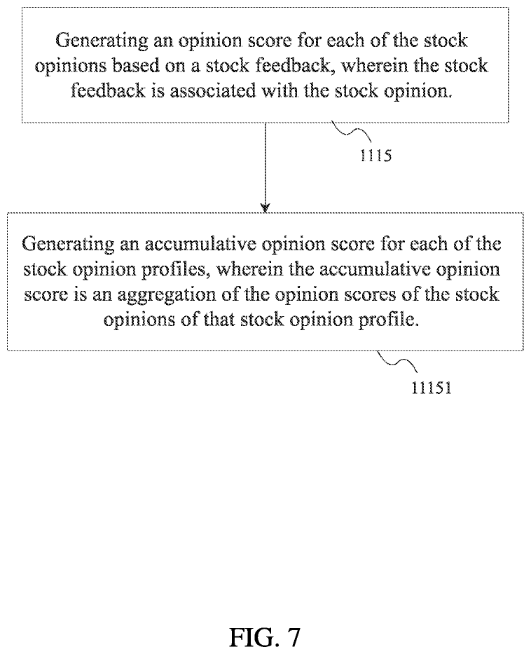

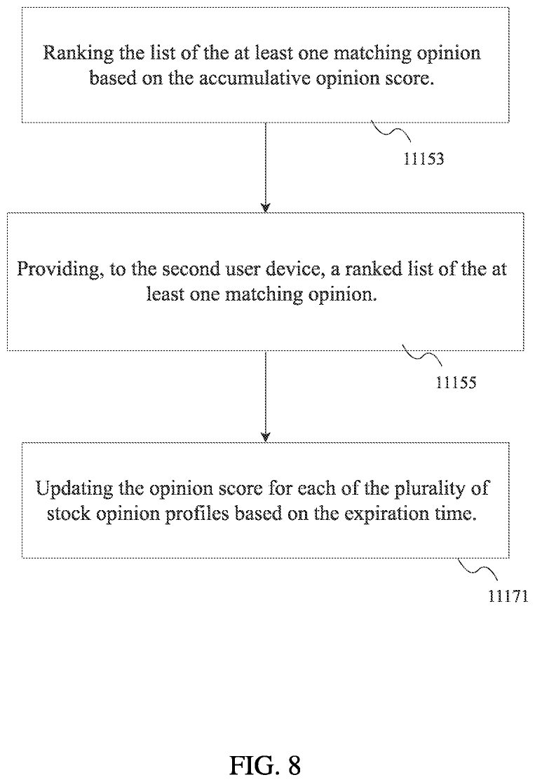

In reference to FIGS. 7-8, an opinion score is generated for each of the stock opinions based on a stock feedback, where the stock feedback is associated with the stock opinion (Step 1115). An accumulative opinion score is generated for each of the stock opinion profiles, where the accumulative opinion score is an aggregation of the opinion scores of the stock opinions of that stock opinion profile (Step 11151). The list of the at least one matching opinion is ranked based on the accumulative opinion score (Step 11153). A ranked list of the at least one matching opinion is provided to the second user device 206 (Step 11155). The opinion score is updated for each of the plurality of stock opinion profiles based on the expiration time (Step 11171). In the preferred embodiment, the opinion score takes the form of a calculated opinion accuracy score that is associated with the stock feedback. The stock feedback takes the form of stock market data analytics, where the stock opinion is compared to the stock market trend analytics. If the prediction of the stock opinion is accurate, then the opinion score is generated as a positive opinion score. If the prediction of the stock opinion is inaccurate, then the opinion score is generated as a negative opinion score. In the preferred embodiment, the generated opinion scores for each of the stock opinion profile is used to determine the accumulative opinion scores of each stock opinion profile. The accumulative opinion scores can be ranked in an opinions leaderboard such that the stock opinion profiles with the highest accumulative opinion scores are shown as the first results. In the preferred embodiment, the opinion score is calculated using an algorithm based on factors of stock volatility, stock opinion duration, or profitability of the stock opinion. In the preferred embodiment, the accumulative opinion score determines the reliability of the opinion profile and determines the risk level of the purchased opinion.

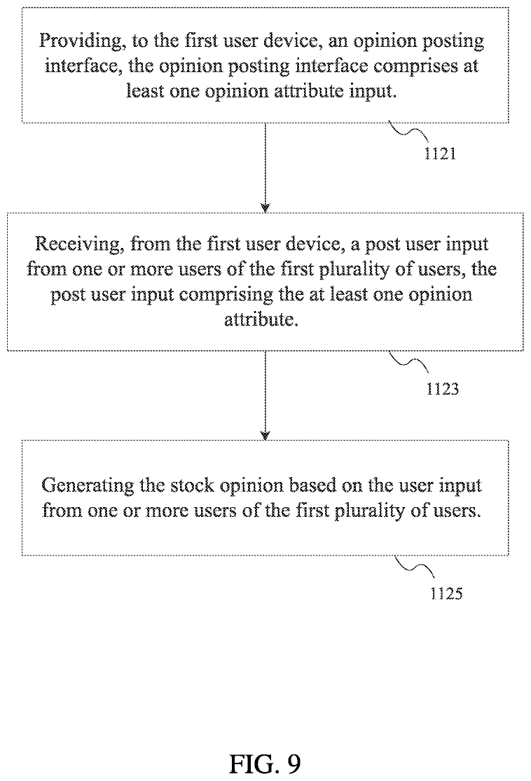

In reference to FIG. 9, an opinion posting interface, where the opinion posting interface comprises at least one opinion attribute input, is provided to the first user device 202 (Step 1121). A post user input from one or more users of the first plurality of users, where the post user input comprises the at least one opinion attribute is received from the first user device 202 (Step 1123). The stock opinion is generated based on the post user input from one or more users of the first plurality of users (Step 1125). In the preferred embodiment, the opinion posting interface takes the form of a user interface suitable for the plurality of first users to input the post user input in order to generate the stock opinion.

In reference to FIG. 10, the present invention further provides a system for providing users with an open opinion marketplace analysis. The system comprises a first user device 202, a second user device 206, and a database server 204, where the first user device 202 is configured to receive the plurality of stock opinion profiles from the first plurality of users, where each stock opinion profile comprises a plurality of stock opinions, and where each stock opinion comprises at least one opinion attribute. In the preferred embodiment, the first user device 202 takes the form of any suitable device associated with user input of the plurality of first users. More specifically, the first user device 202 is the device suitable for processing, storing, or handling user input information pertaining to the plurality of first users, such as, but not limited to desktop computers, laptops, kiosks, portable communication devices, smartphones, tablets, or any other suitable device. The database server 204 is configured to store the plurality of stock opinion profiles. In the preferred embodiment, the database server 204 takes the form of any suitable data storage unit such as, but not limited to database servers.

The second user device 206 is configured to receive a search user input from one or more users of the second plurality of users, where the search user input comprises search criteria for stock opinions. In the preferred embodiment, the second user device 206 takes the form of any suitable device associated with user input of the plurality of second users. More specifically, the second user device 206 is the device suitable for processing, storing, or handling user input information pertaining to the plurality of second users, such as, but not limited to desktop computers, laptops, kiosks, portable communication devices, smartphones, tablets, or any other suitable device. In reference to FIG. 10, the first user device 202, the second user device 206, and the database server 204 are communicably coupled to each other along the overall marketplace hardware system 200. The database server is further configured to create a search preference profile based on the search user input. Next, at least one matching opinion from the plurality of stock opinions of the plurality of stock opinion profiles is identified based on the search preference profile. Next, the search result is generated based on identifying at least one matching opinion, where the search result comprises the list of the at least one matching opinion. In the preferred embodiment, the search preference profile takes the form of an aggregation of search user input data sufficient for finding the at least one matching opinion. The search result takes the form of an aggregation of the at least one matching opinion, where said aggregation is organized into the list of at least one matching opinion. Next, the prompt for selecting from the list of the at least one matching opinion is provided to the second user device 206. The second user device is further configured to receive the response to the prompt from one or more users of the second plurality of users. The database server is further configured to access the at least one opinion attribute of the selected matching opinion based on the response. Finally, the at least one opinion attribute of the selected matching opinion is provided to the second user device 206.

The database server 204 is further configured to providing the transaction interface for processing the transaction from the selected matching opinion after receiving the response to the prompt. The second user device 206 is further configured to receiver the transaction user input from one or more users of the second plurality of users, where the transaction user input comprises transaction payment for the selected matching opinion. The database server 204 is further configured to assign an expiration time for each of the plurality of stock opinions, where at least one opinion attribute comprises the expiration time. Next, the plurality of stock opinions is classified into active stock opinions and expired stock opinions based on the expiration time associated with each of the plurality of stock opinions, where the list of the at least one matching opinion comprises the active stock opinions. The database server 204 is further configured to generate an opinion score for each of the stock based on the stock feedback, wherein the stock feedback is associated with the stock opinion. The list of the at least one matching opinion is ranked based on the opinion score. A ranked list of the at least one matching opinion is provided to the second user device 206. The opinion score is updated for each of the plurality of stock opinion profiles based on the expiration time.

The database server 204 is further configured to generate an opinion score for each of the stock opinions based on the stock feedback, where the stock feedback is associated with the stock opinion. An accumulative opinion score is generated for each of the stock opinion profiles, where the accumulative opinion score is an aggregation of the opinion scores of the stock opinions of that stock opinion profile. The list of the at least one matching opinion is ranked based on the accumulative opinion score. A ranked list of the at least one matching opinion is provided to the second user device 206. The opinion score is updated for each of the plurality of stock opinion profiles based on the expiration time. The database server 204 is further configured to provide an opinion posting interface to the first user interface device, where the opinion posting interface comprises at least one opinion attribute input. The first user device is further configured to receive the post user input from the first user device, one or more users of the first plurality of users, where the post user input comprises the at least one opinion attribute. The database server 204 is further configured to generate the stock opinion based on the post user input from one or more users of the first plurality of users.

Although the invention has been explained in relation to its preferred embodiment, it is to be understood that many other possible modifications and variations can be made without departing from the spirit and scope of the invention as hereinafter claimed.

What is claimed is:

1. A method for providing users with an open opinion marketplace analysis, the method comprising the steps of:
receiving, from a first user device, a plurality of stock opinion profiles from a first plurality of users, each stock opinion profile comprising a plurality of stock opinions, each stock opinion comprising at least one opinion attribute;
storing the plurality of stock opinion profiles in a database server;
receiving, from a second user device, a search user input from one or more users of a second plurality of users, the search user input comprising search criteria for stock opinions;
creating a search preference profile based on the search user input;
identifying at least one matching opinion from the plurality of stock opinions of the plurality of stock opinion profiles based on the search preference profile;
generating a search result based on identifying at least one matching opinion, the search result comprising a list of the at least one matching opinion;
providing, to the second user device, a prompt for selecting from the list of the at least one matching opinion;
receiving, from the second user device, a response to the prompt;
accessing the at least one opinion attribute of a selected matching opinion based on the response; and
providing the at least one opinion attribute of the selected matching opinion to the second user device.

2. The method for providing users with an open opinion marketplace analysis as claimed in claim 1 comprising the steps of:
providing, to the second user device, a transaction interface for processing a transaction from the selected matching opinion after receiving the response to the prompt; and
receiving, from the second user device, a transaction user input from one or more users of the second plurality of users, the transaction user input comprising transaction payment for the selected matching opinion.

3. The method for providing users with an open opinion marketplace analysis as claimed in claim 1 comprising the steps of:
assigning an expiration time for each of the plurality of stock opinions, wherein at least one opinion attribute comprises the expiration time; and
classifying the plurality of stock opinions into active stock opinions and expired stock opinions based on the expiration time associated with each of the plurality of stock opinions, wherein the list of the at least one matching opinion comprises the active stock opinions.

4. The method for providing users with an open opinion marketplace analysis as claimed in claim 3 comprising the steps of:
generating an opinion score for each of the stock opinions based on a stock feedback, wherein the stock feedback is associated with the stock opinion;
ranking the list of the at least one matching opinion based on the opinion score; and
providing, to the second user device, a ranked list of the at least one matching opinion.

5. The method for providing users with an open opinion marketplace analysis as claimed in claim 4 comprising the steps of:
updating the opinion score for each of the plurality of stock opinion profiles based on the expiration time.

6. The method for providing users with an open opinion marketplace analysis as claimed in claim 3 comprising the steps of:
generating an opinion score for each of the stock opinions based on a stock feedback, wherein the stock feedback is associated with the stock opinion; and
generating an accumulative opinion score for each of the stock opinion profiles, wherein the accumulative opinion score is an aggregation of the opinion scores of the stock opinions of that stock opinion profile.

7. The method for providing users with an open opinion marketplace analysis as claimed in claim 6 comprising the steps of:
ranking the list of the at least one matching opinion based on the accumulative opinion score; and
providing, to the second user device, a ranked list of the at least one matching opinion.

8. The method for providing users with an open opinion marketplace analysis as claimed in claim 7 comprising the steps of:
updating the opinion score for each of the plurality of stock opinion profiles based on the expiration time.

9. The method for providing users with an open opinion marketplace analysis as claimed in claim 1 comprising the steps of:
providing, to the first user device, an opinion posting interface, the opinion posting interface comprises at least one opinion attribute input; and
receiving, from the first user device, a post user input from one or more users of the first plurality of users, the post user input comprising the at least one opinion attribute.

10. The method for providing users with an open opinion marketplace analysis as claimed in claim 9 comprising the steps of:
generating the stock opinion based on the post user input from one or more users of the first plurality of users.

11. A system for providing users with an open opinion marketplace analysis, comprising a first user device, a second user device, and a database server,
wherein the first user device is configured for:
receiving a plurality of stock opinion profiles from a first plurality of users, each stock opinion profile comprising a plurality of stock opinions, each stock opinion comprising at least one opinion attribute;
wherein the database server is configured for:
storing the plurality of stock opinion profiles;
wherein the second user device is configured for:
receiving a search user input from one or more users of a second plurality of users, the search user input comprising search criteria for stock opinions;
the database server is further configured for:
creating a search preference profile based on the search user input;
identifying at least one matching opinion from the plurality of stock opinions of the plurality of stock opinion profiles based on the search preference profile;
generating a search result based on identifying at least one matching opinion, the search result comprising a list of the at least one matching opinion;
providing, to the second user device, a prompt for selecting from the list of the at least one matching opinion;
wherein the second user device is further configured for receiving a response to the prompt from one or more users of the second plurality of users;
wherein the database server is further configured for:
accessing the at least one opinion attribute of a selected matching opinion based on the response; and
providing the at least one opinion attribute of the selected matching opinion to the second user device.

12. The system of claim 11, wherein the database server is further configured for:
providing, to the second user device, the transaction interface for processing a transaction from the selected matching opinion after receiving the response to the prompt; and
wherein the second user device is further configured for receiving, from the second user device, a transaction user input from one or more users of the second plurality of users, the transaction user input comprising transaction payment for the selected matching opinion.

13. The system of claim 11, wherein the database server is further configured for:
assigning an expiration time for each of the plurality of stock opinions, wherein at least one opinion attribute comprises the expiration time; and
classifying the plurality of stock opinions into active stock opinions and expired stock opinions based on the expiration time associated with each of the plurality of stock opinions, wherein the list of the at least one matching opinion comprises the active stock opinions.

14. The system of claim 13, wherein the database server is further configured for:
generating an opinion score for each of the stock opinions based on a stock feedback, wherein the stock feedback is associated with the stock opinion;
ranking the list of the at least one matching opinion based on the opinion score; and
providing, to the second user device, a ranked list of the at least one matching opinion.

15. The system of claim 14, wherein the database server is further configured for:
updating the opinion score for each of the plurality of stock opinion profiles based on the expiration time.

16. The system of claim 13, wherein the database server is further configured for:
generating an opinion score for each of the stock opinions based on a stock feedback, wherein the stock feedback is associated with the stock opinion; and
generating an accumulative opinion score for each of the stock opinion profiles, wherein the accumulative opinion score is an aggregation of the opinion scores of the stock opinions of that stock opinion profile.

17. The system of claim 16, wherein the database server is further configured for:
ranking the list of the at least one matching opinion based on the accumulative opinion score; and
providing, to the second user device, a ranked list of the at least one matching opinion.

18. The system of claim 17, wherein the database server is further configured for:
updating the opinion score for each of the plurality of stock opinion profiles based on the expiration time.

19. The system of claim 11, wherein the database server is further configured for:
providing, to the first user device, an opinion posting interface, the opinion posting interface comprises at least one opinion attribute input; and
wherein the first user device is further configured for receiving a post user input from one or more users of the first plurality of users, the post user input comprising the at least one opinion attribute.

20. The system of claim 19, wherein the database server is further configured for:
generating the stock opinion based on the post user input from one or more users of the first plurality of users.
